(19) United States
(12) Patent Application Publication
(10) Pub. No.: US 2002/0160674 A1
(43) Pub. Date: Oct. 31, 2002

(54) Method for bonding a copolyetherester film to copolyester

(76) Inventors: Eberhard Kinkelin, Chur (CH); Peter Kemper, Tomils (CH); Jurgen Spindler, Domat/Ems (CH); Gerhard Poessnecker, Trin (CH)

Correspondence Address: John B. Hardaway, III, NEXSEN PRUET JACOBS & POLLARD, LLC, P.O. Box 10107, Greenville, SC, 29603, US

(21) Appl. No.: 10/085,714

(22) Filed: Feb. 28, 2002

(30) Foreign Application Priority Data
Feb. 28, 2001 (DE) 101 09 622.4

(51) Int. Cl. B32B 5/02; B32B 5/18; B32B 27/04; D04H 1/00; D04H 5/00; D04H 13/00; D04H 3/00; B32B 27/12; B32B 5/22

(52) U.S. Cl. 442/76; 442/86

(57) ABSTRACT

The invention relates to a method for production of a wash-resistant bond between a film on basis of copolyetherester waterproof and permeable to water vapor and at least one substrate on basis of polyester which is a woven or knitted fabric to achieve a pure bonded fabric having good wash resistance at 60° C., wherein said film on basis of copolyetherester which is waterproof and permeable to water vapor is manufactured with at least one film of a hot-melt adhesive on basis of a hydrophilic copolyetherester to a laminate previously before being bonded to said substrate by means of a hot-melt adhesive on basis of copolyester.

### BACKGROUND OF THE INVENTION

1. Field of the Invention

The present invention relates to bonding of breathable films as functional layers to substrates of woven or knitted fabrics by means of copolyesters.

In particular, the invention relates to a method for production of a wash-resistant lamination between a film which is waterproof and permeable to water vapour on basis of copolyetherester and at least one substrate on basis of polyester as a woven fabric or knitted fabric to achieve a bonded fabric of single polymer construction.

2. Background and Prior Art

The invention deals with bonding waterproof ultra light, extremely tight, but permeable to water vapour, i. e. breathable non-porous membranes or films, respectively, on basis of copolyetheresters (such as e. g. Sympatex®, mark of the Sympatex-Technologies) and textile substrates of polyester by the production of a laminate, especially a 2-layered film, consisting of the breathable film and a film of a special copolyester. The invention also relates to the bonding of this laminate (as a functional layer) by means of a copolyester hot-melt adhesive applied to the substrate and especially to the textile polyester substrate to achieve a bonded fabric of single polymer construction which consists of polyester continuously, which is completely recyclable as well as resistant to washing at 60° C., and thus which does not delaminate after multiple washings.

Non-porous membranes which are waterproof but permeable to water vapour are already described variously in the literature and in patent documents. Special materials waterproof and permeable to water vapour made from copolyetheresters were described in U.S. Pat. No. 4,493,870 in 1983. Today, these materials are used worldwide under the term Sympatex®, a mark of the Sympatex-Technologies. Sympatex® is a monolithic membrane assuring that the mentioned properties remain intact with regard to impermeability to water and that the climate-favorable properties of the outer material are not reduced. For example, Sympatex® can be drawn up to 300% in each direction. The Sympatex® membrane has to have only a thickness of 1/100 mm to be effective.

The principle of the breathing-activity can be explained in that there is on the inside and the outside of the membrane a different climate characterized by different water vapour concentrations and temperatures. Thereby, a pressure difference forming the driving force for the transport of water vapour is developed. Hydrophilic components are incorporated in the membrane. The water vapour molecules are attracted by them and are transported across the membrane into direction of the lower vapour pressure by component to component transfer such as in a human hand.

DE 38 83 948 T2 describes a moisture-stable film of a hydrophilic copolyester elastomer layer and a hydrophobic copolyester elastomer layer linked to each other. If the hydrophobic layer has a sufficiently low melting point in relation to the melting point of the hydrophilic layer, it can be used to bond to textile materials such as polyamide, polyethyleneterephthalate, cotton and cellulose triacetate. However, the aforesaid single polymer construction is not present.

Further, it has been known for a long time that polyetherester films having textile interlinings or face fabric of polyester can be bonded only by means of reactive polyurethane systems (see EP 0 382 801 B1, column 3, 1.32-42). Also, the laminates of the breathable film and a polyester textile can be produced by means of a hot-melt adhesive using polyesters or copolyesters. But these laminates are not resistant to multiple washing at 60° C. Hitherto the latter property can thus only be reached by a bond having a reactive polyurethane system. But, by using a polyurethane adhesive the single polymer construction of the whole laminate and thus, the complete recyclability of a single polymer construction is lost. In the year 2000 a novel standard was developed from the textile industry, the so-called bluesign®—standard and related bluesign® label.

The basis for this standard is the highest possible zero-emission and the saving of resources from the textile fibre up to the button and throughout the whole production process of a clothing. An important aspect of this concept is the (chemical) recycling by using polymeric fibres which is only achievable by a single polymer construction of the materials used for clothing.

In relation to the use of a breathable film or membrane, respectively, in the clothing, this means, that all parts have to consist of polyester, but also all materials required for bonded structure also have to consist of polyester. Hitherto, these requirements are not fulfillable, since the wash resistance of a copolyester adhesive for bonding breathing-active films of copolyetherester and polyester textile is not present when a reactive polyurethane adhesive is used the single polymer construction is no longer present and the requirements of the bluesign®—label are not fulfilled.

The technique of bonding by use of a hot-melt adhesive is well known. The hot-melt adhesive is applied on a substrate part in a known manner and subsequently fused and linked to the second substrate under pressure. The coating of the hot-melt adhesive can made either from the granule type by a “hotmelt”-coating or from the powder type by the known methods of scatter coating, double dot coating, paste coating or paste dot coating.

A further method is the coating by a converted type of the hot-melt adhesive such as e.g. as film or as web.

Further, woven fabrics or knitted fabrics can comprise hot-melt binding fibres. For example, DE 38 26 089 A1 describes a non-woven fabric enriched with bonding binding fibres making a hot-melt adhesive contact to the film which is waterproof and permeable to water vapour. However, in the binding which is disclosed the fibres can melt together into larger areas

Only the technique of forming the bond in a dot matrix pattern is considered to bond a film permeable to water vapour, since the special properties of the film are not enabled any more by a full-area type lamination.

However, despite the coating method, all bonds made between a copolyetherester film and a textile of polyester by means of a hot-melt adhesive of copolyester show a good original adhesion, but an insufficient adhesion after several washings without exception.

Thus, it is object of the present invention to provide a wash-resistant bond to film on basis of copolyetherester and a textile fabric on basis of polyester using a hot-melt adhesive which is a copolyester. This object is achieved by a method for the production of a wash-resistant bond between a film on basis of copolyetherester which is waterproof and water vapour permeable and at least one woven or knitted fabric as a substrate on basis of polyester wherein said film on basis of copolyetherester is manufactured with at least one film of a hot-melt adhesive on basis of hydrophilic copolyetherester to a laminate previously before being bonded to said substrate by means of a hot-melt adhesive on basis of copolyester and wherein said film of a hot melt adhesive comprising hydrophilic copolyetheresters is formed from terephthalic acid and a combination of alcohols selected from the group consisting of butanediol, diethylene glycol, triethylene glycol and polyethylene glycols having a molecular weight of 600 to 400 g/mol, as well as by the bonded fabric made by the method;

by a fabric according to the method which conforms to the bluesign® standard; and

by a fabric wherein said waterproof and water vapour permeable layers is a copolyetherester comprising multiple recurring long-chain and short-chain units linked head to tail, said long chain units corresponding to formula (I).

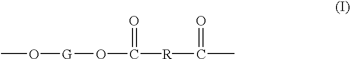

and said short claim units correspond to formula (II)

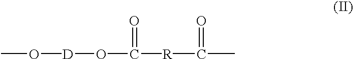

wherein

G represents a bivalent residue derived by removal of terminal hydroxyl groups, from at least one long-chain glycol having an average molecular weight of 600 to 6000 and an atomic ratio of carbon to oxygen between 2.0 and 4.3, wherein at least 20 wt.-% of said long-chain glycol have an atomic ratio of carbon to oxygen between 2.0 and 2.4 and are 15 to 50 wt.-% of said copolyetherester,

R represents a bivalent residue derived by removal of carboxyl groups from at least one dicarboxylic acid of a molecular weight of less than 300, and

D represents a bivalent residue derived by removal of hydroxyl groups from at least one diol of a molecular weight of less than 250, wherein at least 80 mol-% of used dicarboxylic acid consist of terephthalic acid or ester-forming equivalents thereof and at least 80 mol-% of said diol have said small molecular weight consisting of 1,4-butanediol or ester-forming equivalents therefore, the sum of mole percents of said dicarboxylic acid which does not represent terephthalic acid or ester-forming equivalents thereof and of said diol having a small molecular weight which does not represent 1,4-butanediol or ester-forming equivalents thereof being not more than 20% and wherein said short-chain units of ester can be 40 to 80 wt.-% of said copolyetherester.

### BRIEF SUMMARY OF THE INVENTION

the inventors of the present application have found a method to ensure the single polymer construction of a bonded fabric, while simultaneously achieving a very good wash resistance.

It has been discovered that instead of using a pure breathing-active film, e. g. of Sympatex® etc., a two-layered film consisting of the breathable film can be bonded by means of known bonding techniques to a polyester substrate which can be for example, a textile interlining or face fabric or face fabric and lining fabric using a chemically related copolyester hot meat adhesive. The very good original adhesion does not decrease upon several washings.

The production of a two-layered film of the breathing-active film and the layer of the copolyetherester hot-melt adhesive (laminate) is possible by coextruding two materials as blown film or also as flat film. Alternatively, it may be from the lamination of a hot-melt adhesive film on the breathable film.

### DETAILED DESCRIPTION OF THE INVENTION

The laminate used in the method according to the present invention can be formed as a two layered laminate or a three-layered laminate. In particular, the two-layered laminate is a face fabric laminate, an insert laminate and/or a lining laminate. In the face fabric laminate one side of the face fabric is connected directly to the membrane by means of the chemically related hot-melt adhesive film on basis of hydrophilic copolyetheresters by means of a hot-melt adhesive. The lining fabric underlies loosely.

In insert laminates, the Sympatex® membrane is laminated to a textile backing such as a non-woven fabric or a knitted fabric with an added chemically related copolyester hot-melt adhesive layer and clings loosely between face fabric and lining fabric. This variant is used predominantly for fashionable clothing due to the freedom of choices allowed for the selection and construction of face fabric.

In lining laminates, the lining fabric (woven fabric, knitted fabric, non-woven fabric) is connected on the first side to the membrane by means of the chemically related copolyester hot-melt adhesive layer by means of dot matrix pattern of hot-melt adhesive. The face fabric overlies it loosely. This laminate is especially preferred for extremely light and soft-textured jackets.

In the three layered laminate according to the present invention the Sympatex® membrane is connected firmly to the face fabric and lining fabric over the hydrophilic copolyetherester. Three layered laminates are robust and long-lived and thus, are used especially for particularly longwearing clothing.

While the thickness of the film which is waterproof and permeable to water vapour is between 5 and 50 μm, the laminated copolyester film using a hot-melt adhesive on basis of hydrophilic copolyetheresters has a thickness of 5 to 80 μm, preferably 5 to 35 μm.

The hot-melt adhesive material which shall be used for the laminated film has to be closely related chemically to the used breathable film on basis of polyetherester to ensure the permeability to water vapour of the final bonded fabric. These hot-melt adhesives of hydrophilic copolyetheresters consist of terephathlic acid as a single dicarboxylic acid component and a diol mixture of butanediol, diethylene glycol and/or triethyleneglycol. In addition 2 to 10 mol-% (based on the whole amount of acid and diol) of a higher molecular polyethylene glycol component having a molecular weight of 600-4000 g/mol is added. The melting points of such copolyetheresters are between 90 and 190° C. The amount of butanediol is less than 75 mol-%. The amount of diethylene glycol is between 5 and 60 mol-%. The amount of triethyleneglycol is between 0 and 40 mol-%. Preferably the molecular amount of butanediol is between 40 and 70 mol-% based on the total amount of diol as 100 mol-%. In an especially preferred embodiment the molecular amount of diethylene glycol is between 10 and 50 mol-% and the molecular amount of triethyleneglycol is preferably between 0 and 35 mol-% based on the total amount of diol as 100 mol-%. If diethylene glycol and triethyleneglycol are used simultaneously the molecular ratio of diethylene glycol to triethyleneglycol is preferably between 5:1 and 1:3. To increase the melt viscosity of the copolyetherester hot-melt adhesive masses, a trivalent or multivalent diol of not more than 2 mol-% based on the whole amount of diol can be used. The melt viscosity of the copolyetheresters, as measured at 190° C. and load of 2.16 kg according to ISO/DIN 1133, is not below 100 Pa.s, preferably it is not below 200 Pa.s. In particular, a molecular amount of butanediol of 45-70 mol-%, an amount of diethylene glycol of 26-50 mol-% and an amount of a higher molecular polyethylene glycol component having a molecular weight of 600-4000 g/mol of 4 to 8 mol-% are considered as diol component for the hydrophilic copolyetheresters.

As copolyetherester for the film or membrane waterproof and permeable to water vapour are selected copolyetheresters consisting of a multitude of recurring interlinear long-chain and short-chain units of ester being statistically linked by ester linkages head to tail, the long-chain units of ester corresponding to formula (I)

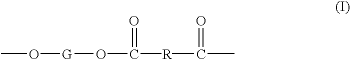

and the short-chain units of ester corresponding to formula (II)

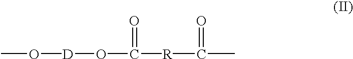

wherein

G represents a bivalent residue derived by removal of terminal hydroxyl groups, from at least one long-chain glycol having an average molecular weight of 600 to 6000 and an atomic ratio of carbon to oxygen between 2.0 and 4.3, at least 20 wt.-% of the long-chain glycol having an atomic ratio of carbon to oxygen between 2.0 and 2.4 and being 15 to 50 wt.-% of the copolyetherester,

R represents a bivalent residue derived by removal of carboxyl groups from at least one dicarboxylic acid of a molecular weight of less than 300, and

D represents a bivalent residue derived by removal of hydroxyl groups from at least one diol of a molecular weight of less than 250, at least 80 mol-% of dicarboxylic acid consisting of terephthalic acid or ester-forming equivalents thereof and at least 80 mol-% of the diol having said small molecular weight consisting of 1,4-butanediol or ester-forming equivalents therefore, the sum of mole percents of the dicarboxylic acid which does not represent terephthalic acid or ester-forming equivalents thereof and of the diol having a small molecular weight which does not represents 1,4-butanediol or ester-forming equivalents thereof being not more than 20% and wherein the short-chain units of ester can be 40 to 80 wt.-% of the copolyetherester.

Appropriate copolyetheresters are described in EP 0 382 801 B1 which is incorporated by reference herein.

In addition, the second layer of the composite film or the laminated hot-melt adhesive film, respectively has to be relatively high melting to avoid a fusion of the two-layered film or the laminate, respectively during bonding to the polyester face fabric. This bonding does not occur over the full area so that there is no reduction of the permeability to water vapour. Therefore, the technique of the paste dot coating is selected preferably, but also the powder dot coating or scatter coating are possible. Thereby, a copolyester powder having melting point of maximum 140° C., preferably of about 120° C. serves as hot-melt adhesive to hold the processing temperature below the melting temperature of the two-layered film or bonded film. Griltex® 9E, a produce of EMS-Griltech, Domat/Ems, Switzerland can be considered as a preferred copolyester hot-melt adhesive.

The substrate, especially a face fabric, need not be compulsorily polyester. In case of such composition the single polymer construction is not present, but the present method according to the present invention has the advantage that the lamination between copolyetherester film and substrate does not have to occur directly, as required by the use of a reactive polyurethane adhesive, but that the coated substrate can be bonded in a later operating cycle to the two layered film or to the film laminate.

In the following examples, the method according to the invention is explained in detail. Original adhesion and the adhesion after washing for 5 times at 60° C. were determined according to DIN 53920 as the criterion for the bond quality. Additionally, the permeability to water vapour was determined before and after washing at 60° C. according ASTM E-96-66.

### EXAMPLE 1

In a 101 esterification reactor provided with temperature probe, stirrer, reflux column and distillation tube 1.37 kg (1.52 mol) of butanediol, 0.98 kg (0.93 mol) of diethylene glycol and 0.89 kg (0.15 mol) of polyethylene glycol having an average molecular weight of 600 are added and fused at 140° C. under an atmosphere of nitrogen maintained during the whole reaction. Terephthalic acid 3.08 kg (1.85 mol) and 3 g of esterification catalyst are added while stirring. Upon stepwise increase of the internal temperature to 235° C. the reaction is continued until no distillate arises. Subsequently, 6 g of esterification catalyst and 3 g of heat stabilizer are added. The temperature is increased to 250° C. and vacuum is applied stepwisely until a terminal vacuum of <1 mbar is achieved. The condensation is continued for at least 2 hours until the desired viscosity is achieved.

The obtained copolyetherester hot-melt adhesive has, after drying for 12 hours at 60° C. a melting point of about 157° C., a glass transition temperature Tg of about 0° C. and a melting viscosity of 400 Pa.s, as measured at 190° C. and load of 2.16 kg.

### EXAMPLE 2

On a flat film installation (manufacturer: Company Collin, Ebersberg, Germany) a two-layered film was produced from Sympatex® (mark of the Sympatex-Technologies) and the hot-melt adhesive of Example 1. Each layer has a thickness of about 25 μm.

### EXAMPLE 3

A film from Sympatex® (mark of the Sympatex-Technologies) was laminated to a film of the hot-melt adhesive of Example 1. The hot-melt adhesive film was produced on a flat film installation (manufacturer: Company Collin, Ebersberg, Germany) with a thickness of 25 μm. The Sympatex® film was pressed with the hot-melt adhesive film according to the present invention on a Meyer press at 155° C. under a pressure of 5 N/cm² for 8 seconds.

### EXAMPLE 4

A commercial polyester face fabric and the two-layered film of Example 2 were bonded with a copolyester hot-melt adhesive (Griltex® 9E from EMS-Griltech) on basis of modified polybutyleneterephthalate having a melting point of 119° C. by means of a powder dot coating. Thereby, the polyester face fabric was bonded to the hot-melt adhesive side of the two-layered film. The copolyester hot-melt adhesive was applied in the powder fraction 80-200 μm and with a coating weight of 12 g/m² on the face fabric and sintered. The bond to the two-layered film was carried out on a Meyer press at 135° C., a pressure of 5 N/cm² and a residence time of 12 seconds.

### EXAMPLE 5

A commercial polyester face fabric and the film laminate of Example 3 were bonded with a copolyester hot-melt adhesive (Griltex® 9E from Company EMS-Griltech, Domat/Ems, Switzerland) on basis of modified polybutyleneterephthalate having a melting point of 119° C. by means of a powder dot coating. Thereby, the polyester face fabric was bonded to the hot-melt adhesive side of the film laminate. The copolyester hot-melt adhesive was applied in the powder fraction 80-200 μM and with a coating weight of 12 g/m² on the face fabric and sintered. The bond to the film laminate was carried out on a Meyer press at 135° C., a pressure of 5 N/cm² and a residence time of 12 seconds.

### EXAMPLE 6

For comparison, a commercial polyester face fabric and a commercial film Sympatex® (mark of the Sympatex-Technologies) were bonded with a copolyester hot-melt adhesive (Griltex® 9E from Company EMS-Griltech, Domat/Ems, Switzerland) by means of a powder dot coating. The copolyester hot-melt adhesive was applied in the powder fraction 80-200 μm and with a coating weight of 12 g/m² on the face fabric and sintered. The bond was carried out on a Meyer press at 135° C., a pressure of 5 N/cm² and a residence time of 12 seconds.

### EXAMPLE 7

The original adhesion of the laminated fabric of the Examples 4-6 as well as the adhesion upon washing for 5 times at 60° C. were measured. Additionally, the permeability to water vapour according to ASTM E-96-66 was determined before and after washing.

Five cm wide textile laminates were clamped in a draw machine to measure the adhesive force. The test parameter was constant for all measurements.

| | |
|---|---|
| test velocity | 100 mm/min |
| width of specimen | 50 mm |
| test length | 80 mm |
| preload | ON |
| test temperature | 25° C. |

The results are represented in Table 1.

TABLE 1

| | | | comparison |
|---|---|---|---|
| | Example 4 | Example 5 | example 6 |
| Original adhesion | >12 | >12 | >12 |
| [N/5 cm] | (tear of | (tear of | (tear of |
| | substrate) | substrate) | substrate) |
| Adhesion after | >12 | >12 | delamination |
| washing for | | | |
| 5× at 60° C. | (tear of | (tear of | |
| [N/5 cm] | substrate) | substrate) | |
| permeability | 2731 | 2699 | 2745 |
| to water | | | |
| vapour | | | |
| [g/m² in 24 h] | | | |
| permeability | 2517 | 2509 | delamination |
| to water | | | |
| vapour after | | | |
| washing for 5× | | | |
| at 60° C. [g/m² | | | |
| in 24 h] | | | |

While the invention has been disclosed in the patent application by reference to the details of preferred embodiments of the invention, it is to be understood that the disclosure is intended in an illustrative rather than a limiting sense as it is contemplated that modifications will readily occur to those skilled in the art within the spirit of the invention and the scope of the appended claims.

1. A method for the production of a wash-resistant bond between a film on basis of copolyetherester which is waterproof and water vapour permeable and at least one woven or knitted fabric as a substrate on basis of polyester wherein said film on basis of copolyetherester is manufactured with at least one film of a hot-melt adhesive on basis of hydrophilic copolyetherester to a laminate previously before being bonded to said substrate by means of a hot-melt adhesive on basis of copolyester and wherein said film of a hot-melt adhesive comprising hydrophilic copolyetheresters is formed from terephthalic acid and a combination of alcohols selected from the group consisting of butanediol, diethylene glycol, triethylene glycol and polyethylene glycols having a molecular weight of 600 to 4000 g/mol.

2. A method according to claim 1 wherein said diethylene glycol is present in 5 to 60 mol-%, said triethylene glycol is present in an amount between 5 and 60 mol-% and said triethylene glycol is present in an amount between 0 and 40 mol-% based on 100% acid and said high molecular weight polyethylene glycol is present ins an amount 75 to 60 mol-% based on the amount of total glycol.

3. A method according to claim 1 wherein said film which is waterproof and water vapour permeable comprises multiple recurring long-chain and short-chain units linked head to tail, said long chain units corresponding to formula (I). 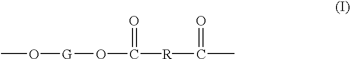
and said short claim units correspond to formula (II) 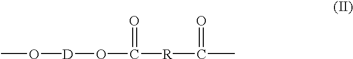
wherein
G represents a bivalent residue derived by removal of terminal hydroxyl groups from at least one long-chain glycol having an average molecular weight of 600 to 6000 and an atomic ratio of carbon to oxygen between 2.0 and 4.3, wherein at least 20 wt.-% of said long-chain glycol have an atomic ratio of carbon to oxygen between 2.0 and 2.4 and are 15 to 50 wt.-% of said copolyetherester,
R represents a bivalent residue derived by removal of carboxyl groups from at least one dicarboxylic acid of a molecular weight of less than 300, and
D represents a bivalent residue derived by removal of hydroxyl groups from at least one diol of a molecular weight of less than 250, wherein at least 80 mol-% of used dicarboxylic acid consist of terephthalic acid or ester-forming equivalents thereof and at least 80 mol-% of said diol have said small molecular weight consisting of 1,4-butanediol or ester-forming equivalents therefore, the sum of mole percents of said dicarboxylic acid which does not represent terephthalic acid or ester-forming equivalents thereof and of said diol having a small molecular weight which does not represent 1,4-butanediol or ester-forming equivalents thereof being not more than 20% and wherein said short-chain units of ester can be 40 to 80 wt.-% of said copolyetherester.

4. A method according to claim 1 wherein said substrate is selected from the group consisting of non-woven fabric, knitted fabric and lining fabric.

5. A method according to claim 1 wherein said film of a hot melt adhesive on basis of copolyetherester has a melting point of at least 150° C.

6. A method according to claim 1 wherein said hot melt adhesive on basis of copolyester is applied using a method selected from the group consisting of paste dot coating, powder dot coating and scatter coating.

7. A fabric comprising at least one substrate and laminate in form of a film on basis of copolyetherester which is waterproof and permeable to water vapour in combination with at least one film of a hot-melt adhesive on basis of hydrophilic copolyetherester, said substrate and laminante being adhered using a hot-melt adhesive.

8. A fabric according to claim 7 which conforms to the bluesign® standard.

9. A fabric according to claim 7 wherein said waterproof and water vapour permeable layers is a copolyetherester comprising multiple recurring long-chain and short-chain units linked head to tail, said long chain units corresponding to formula (I). 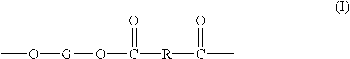
and said short claim units correspond to formula (II) 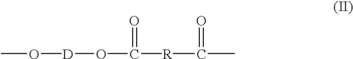
wherein
G represents a bivalent residue derived by removal of terminal hydroxyl groups, from at least one long-chain glycol having an average molecular weight of 600 to 6000 and an atomic ratio of carbon to oxygen between 2.0 and 4.3, wherein at least 20 wt.-% of said long-chain glycol have an atomic ratio of carbon to oxygen between 2.0 and 2.4 and are 15 to 50 wt.-% of said copolyetherester,
R represents a bivalent residue derived by removal of carboxyl groups from at least one dicarboxylic acid of a molecular weight of less than 300, and
D represents a bivalent residue derived by removal of hydroxyl groups from at least one diol of a molecular weight of less than 250, wherein at least 80 mol-% of used dicarboxylic acid consist of terephthalic acid or ester-forming equivalents thereof and at least 80 mol-% of said diol have said small molecular weight consisting of 1,4-butanediol or ester-forming equivalents therefore, the sum of mole percents of said dicarboxylic acid which does not represent terephthalic acid or ester-forming equivalents thereof and of said diol having a small molecular weight which does not represent 1,4-butanediol or ester-forming equivalents thereof being not more than 20% and wherein said short-chain units of ester can be 40 to 80 wt.-% of said copolyetherester.
